(19) United States
(12) Patent Application Publication
(10) Pub. No.: US 2026/0168311 A1
(43) Pub. Date: Jun. 18, 2026

(54) SYSTEM AND METHOD FOR RECOVERY OF AUTOMATICALLY CLOSING VEHICLE DOORS

(71) Applicant: GM GLOBAL TECHNOLOGY OPERATIONS LLC, Detroit, MI (US)

(72) Inventors: Thiago Laserra Lima, Sterling Heights, MI (US); Mati Goro, Sterling Heights, MI (US); Sitaram Emani, Novi, MI (US); Carlos S. Jabbour, Shelby Township, MI (US)

(73) Assignee: GM GLOBAL TECHNOLOGY OPERATIONS LLC, Detroit, MI (US)

(21) Appl. No.: 18/978,734

(22) Filed: Dec. 12, 2024

(51) Int. Cl. E05F 15/70

(52) U.S. Cl. CPC E05F 15/70; E05Y 2201/71; E05Y 2400/358; E05Y 2400/446; E05Y 2900/531

(57) ABSTRACT

A system for operating an access door in a vehicle having a vehicle body includes a powertrain configured to operate the vehicle in propulsion mode. The system also includes a door mechanism configured to latch the door to the body and an actuator configured to apply a force to the door to affect door closure and latching. The system additionally includes an electronic controller configured to identify when the vehicle is in motion and detect when the access door is not fully closed and latched. The controller is also configured to determine when the force required to fully close and latch the door using the actuator exceeds a threshold force value. The controller is further configured to trigger the actuator to apply a first force exceeding the threshold force value to fully close and latch the door.

### INTRODUCTION

The present disclosure is drawn to a recovery strategy, including system and method, for automatically closing vehicle doors.

A typical vehicle has at least one door to provide vehicle user access to the vehicle's interior. Generally, such access doors are either hinged to swing-out relative to the vehicle body or are configured to slide relative thereto. An access door typically has a latch mechanism for maintaining the door in a closed state until access into or egress from the vehicle is required. The door latch mechanism is generally actuated by an outside door handle to gain access to the interior of the vehicle and by an interior door handle to permit the occupant to exit the vehicle interior.

Vehicles frequently have enclosed cargo areas positioned either at the front or at the rear end of the vehicle body. The design of such cargo enclosures typically includes a hinged cargo door, such as a deck-lid or a tailgate for security and convenient access. Generally, similar to vehicle side doors, cargo enclosure doors employ latch mechanisms for maintaining the enclosure in a closed state until access thereto is required. In modern vehicles, latch mechanisms for both the side doors and cargo doors are frequently power actuated. Additionally, some vehicles offer automatic and/or remote actuation of respective doors.

### SUMMARY

A system for operating an access door in a vehicle having a vehicle body includes a powertrain configured to operate the vehicle in propulsion mode. The system also includes a door mechanism configured to latch the door to the vehicle body, an actuator configured to apply a force to the door to affect door closure and latching, and a sensor configured to detect a state of the access door relative to the vehicle body. The system additionally includes an electronic controller in communication with the actuator and the door position sensor, and configured to detect when the vehicle is in motion and the access door is not fully closed and latched. The electronic controller is also configured to determine when the force required to fully close and latch the door using the actuator exceeds a threshold force value. The electronic controller is further configured to use the actuator to apply a first force exceeding the threshold force value to fully close and latch the door.

The electronic controller may be configured to apply the first force by triggering a series of first predetermined (100%) pulse width modulated (PWM) signals, for example as a plurality of rapid PWM signals.

The electronic controller may be configured to apply the first force by increasing voltage to the actuator.

The electronic controller may be configured to apply the first force by engaging a reduction gear with the actuator.

The electronic controller may also be configured to determine when the force required to fully close and latch the door doesn't exceed the threshold force value. In such an embodiment, the electronic controller may be additionally configured to trigger the actuator to apply a second force not exceeding the threshold force value to fully close and latch the door.

The electronic controller may be configured to apply the second force by triggering a second predetermined pulse width modulated (PWM) signal.

The electronic controller may also be configured to, following the application of the second force, determine using the sensor when the access door has not fully closed and latched. In such an embodiment, the electronic controller may be additionally configured to continue applying the second force to maintain a closing force on the door and thereby block the door from opening, such as until a vehicle operator attends to the door.

The electronic controller may be configured to determine when the force required to fully close and latch the door exceeds the threshold force value by determining when the vehicle is situated on an incline tending to resist closure of the door. In such an embodiment, the subject incline exceeds a threshold angle value programmed into the electronic controller.

The electronic controller may be configured to determine when the force required to fully close and latch the door exceeds the threshold force value by determining when ambient temperature exceeds a first threshold temperature value.

The electronic controller may be configured to determine when the force required to fully close and latch the door exceeds the threshold force value by determining when ambient temperature is below a second threshold temperature value.

The electronic controller may be additionally configured to determine when the full closure and latching of the door has failed and trigger a sensory signal or alert to the vehicle operator.

The electronic controller may be additionally configured to determine when the full closure and latching of the door has failed and triggers and displays a countdown timer to the vehicle operator before power closing the door.

A method for operating an access door using the above-described system is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of a vehicle having a passenger compartment and a cargo enclosure with respective access doors and having a system for automatic operation of subject access doors, according to the disclosure.

FIG. 2 is a schematic top view of the vehicle shown in FIG. 1, illustrating one of the access doors in an open state and a door actuator applying a closing force to the subject door, according to the disclosure.

FIG. 3 is a side view of the vehicle shown in FIG. 2, illustrating the vehicle situated on an incline, according to the disclosure.

FIG. 4 illustrates, in flow chart format, a method of operating an access door in a vehicle as shown in FIGS. 1-3, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

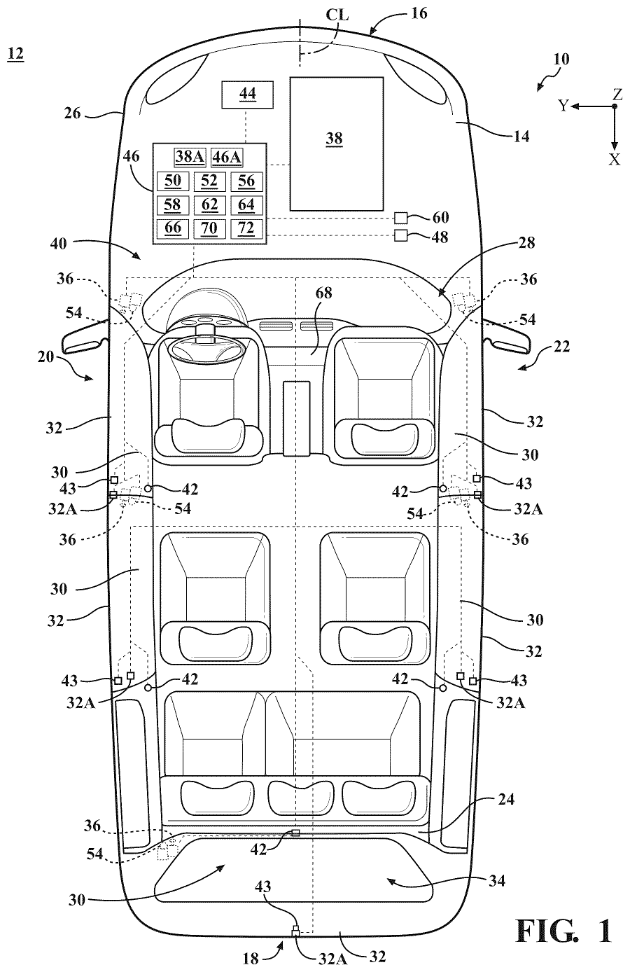

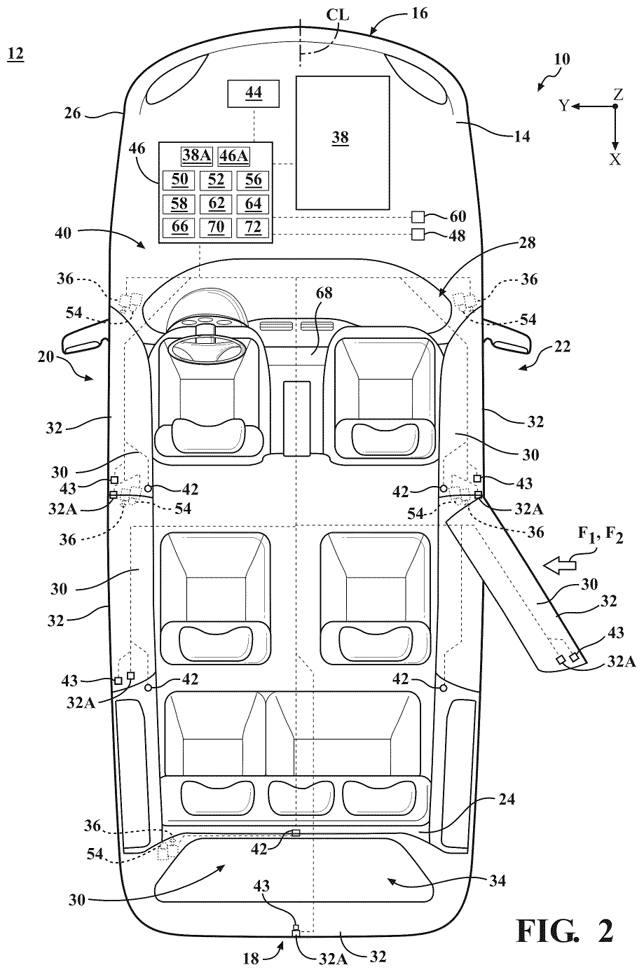

Referring to the drawings, wherein like reference numbers refer to like components, FIGS. 1 and 2 show a schematic view of a motor vehicle 10 positioned relative to a road surface 12 in an X-Y plane. The vehicle 10 includes a vehicle body 14. As shown, the vehicle body 14 is arranged relative to a longitudinal centerline CL. The vehicle body 14 generally defines six body sides. The six body sides include a first body end or front end 16, an opposing second body end or rear end 18, a first lateral body side or left side 20, a second lateral body side or right side 22, a top body portion 24, which may include a vehicle roof, and an underbody portion (not shown) generally facing the road surface 12. The left side 20 and right side 22 are disposed generally parallel to each other and with respect to the longitudinal centerline CL of the vehicle body 14 and span the distance between the front end 16 and the rear end 18.

The body sides 16, 18, 20, 22, 24, together with the underbody portion define a vehicle exterior 26. The body 14 also defines a vehicle passenger compartment or interior 28. The passenger compartment 28 is adapted to accommodate vehicle passengers and their belongings. As shown in FIG. 1, the vehicle 10 also includes at least one access opening 30 that is defined by the body 14 and provides access to the vehicle interior 28. Although, as shown, the vehicle body 14 defines five individual access openings 30, nothing preclude the vehicle body from having a smaller or greater number of access openings. The vehicle 10 also includes a number of access doors 32, one door for each of the access openings 30. Each of the side access doors 32 may be pivotable outward or slide along the X-axis relative to the vehicle body 14 and be latched to the vehicle body in a closed position. Accordingly, each access door 32 is configured to selectively cover and uncover at least a portion of the respective access opening 30 to control passage between the vehicle exterior 26 and the vehicle interior 28.

As shown in FIGS. 1 and 2, four of the access openings 30 are side entries configured to provide access to the passenger compartment 28, while the fifth opening 30 provides access into a cargo enclosure 34 at the rear end 18. As shown, the access door 32 may be configured as a tailgate for a fully or partially enclosed cargo area, wherein at least one side of the trunk is open to the passenger compartment 28. Although not shown, cargo enclosure 34 may also be configured as a separate compartment, such as a fully enclosed trunk, for instance in a traditional three-box sedan body style, with the respective access door 32 operating as a hinged deck-lid. The tailgate or the deck-lid types of access door 32 are typically hinged at the rear end 18 to swing up and/or out relative to the vehicle body 14.

Although the cargo enclosure 34 is primarily described and shown throughout the Figures as being arranged at the rear end 18 of the vehicle body 14, such a cargo enclosure may also be arranged proximate the front end 16. Such a front-positioned cargo enclosure 34 (not shown) may, for example, be used in a rear-engine or a mid-engine vehicle. The disclosed tailgate is of the type that is frequently used for access to the interiors and storage compartments in vans, station wagons, and sport utility vehicles (SUVs). As envisioned herein, each access door 32 includes a mechanism 32A (shown in FIGS. 1 and 2) configured to selectively latch the door to the vehicle body 14 and release the door therefrom. The mechanism 32A may include individual components, some of which may be mounted to the actual door 32 and some to the vehicle body 14. Vehicle 10 also incorporates a drive unit or actuator 36 (e.g., employing an electric motor and a gear or a worm drive) for each access door 32. Each actuator 36 is configured to apply a force (and a resultant torque) to the corresponding door 32 to affect closing (and optionally, opening) thereof. The closing of the respective access door 32 via the actuator 36 permits the mechanism 32A to automatically latch the corresponding door to the vehicle body 14.

As shown in FIGS. 1 and 2, vehicle 10 also includes a powertrain 38 having a powerplant (not shown) configured to operate the vehicle in propulsion mode 38A, such as via application of powertrain torque. The propulsion mode 38A may be activated via vehicle being keyed-on and the powertrain 38 being set in drive or reverse operating range, i.e., out of park. The vehicle 10 may then be powered via the powerplant when vehicle brakes are not engaged. A powertrain neutral range may also be selected in which the vehicle 10 may be moved, but not under its own power. The powertrain 38 may also include a transmission assembly (not shown) configured to select the subject operating ranges when the vehicle has been keyed-on.

With continued reference to FIGS. 1 and 2, vehicle 10 additionally includes a system 40 for operating an access door 32, including a recovery strategy, for automatically closing vehicle doors, such as the doors described above, of the subject vehicle 10. The recovery strategy is implemented in the event an access door 32 is not closed and latched by the vehicle operator prior to initiation of vehicle movement. System 40 may include door position or proximity sensors 42, each sensor 42 being mounted to the vehicle body 14 proximate to a respective one of the access doors 32. Additionally, vehicle 10 may include latch sensors 43 configured to detect the latching status of corresponding mechanisms 32A, i.e., whether the respective mechanism is latched or not. Sensors 43 may be mounted to corresponding doors 32 or to the vehicle body 14. Accordingly, each sensor 42 and 43 is configured to detect a state of the corresponding access door 32 relative to the vehicle body 14, which may be used to determine whether the corresponding access door 32 has been fully closed and latched. Vehicle 10 also includes an energy storage device 44, such as one or more rechargeable batteries, providing 12-volt or 48-volt power. System 40 further includes an electronic controller 46 mounted on the vehicle 10 and in operative communication with the door position sensors 42, latch sensor 43, and the respective actuators 36. The electronic controller 46 may be a central processing unit (CPU) or a body control module (BCM) configured to receive data signals from various vehicle sensors and regulate operation of vehicle systems, including the system 40.

The electronic controller 46 may be in operative communication with such vehicle systems and sensors via a data network, e.g., a Controller Area Network (CAN bus), arranged in the vehicle 10. The energy storage device 44 is used for generating electrical power to operate vehicle sensors, such as sensors 42 and 43, electronic controller 46, as well as various other vehicle systems, such as a powertrain, lighting, infotainment, and heating, ventilation, and air conditioning (HVAC). The electronic controller 46 includes a memory that is tangible and non-transitory. The controller's memory may be a recordable medium that participates in providing computer-readable data or process instructions. Such a medium may take many forms, including but not limited to non-volatile media and volatile media. Non-volatile media used by the electronic controller 46 may include, for example, optical or magnetic disks and other persistent memory.

Volatile media of each of the controller's memory may include, for example, dynamic random-access memory (DRAM), which may constitute a main memory. Such instructions may be transmitted by one or more transmission medium, including coaxial cables, copper wire and fiber optics, including the wires that comprise a system bus coupled to the vehicle systems. Memory of the electronic controller 46 may also include a flexible disk, hard disk, magnetic tape, other magnetic medium, a CD-ROM, DVD, other optical medium, etc. The electronic controller 46 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 46 or accessible thereby, generally indicated via numeral 46A, may be programmed in the controller, stored in the memory, and automatically executed to provide the required functionality, such as for operating the system 40.

The electronic controller 46 is configured, i.e., structured and programmed, to identify or detect when vehicle 10 is in motion relative to the road surface 12. Such a determination may be made based on whether the vehicle 10 is in propulsion mode 38A or using a vehicle position or motion sensor 48. The electronic controller 46 is also configured to determine, using the door position sensors 42 and/or the latch sensors 43, when one or more access doors 32 are not fully closed and latched (shown in FIG. 2). The electronic controller 46 is additionally configured to determine when the force required to fully close and latch a particular door 32 via the actuator 36 exceeds a threshold force value 50 (representing a closing force sufficient under normal conditions). The electronic controller 46 is further configured to trigger the actuator 36 to apply a first force F₁ (and a resultant torque) exceeding the threshold force value 50 to fully close and latch the subject door 32. The first force F₁ may be generated by providing additional or boosted electrical power to the corresponding actuator 36 or increasing the actuator's output force via mechanical means.

The electronic controller 46 may be configured to apply the first force F₁ via the actuator 36 by triggering a series of first predetermined (100%) pulse width modulated (PWM) signals 52, e.g., a plurality of signals in rapid succession, using the energy storage device 44 or a voltage booster (not shown). The electronic controller 46 may also be configured to apply the first force F₁ by increasing voltage provided to the actuator 36 by the energy storage device 44. Alternatively, or in addition to, the electronic controller 46 may be configured to apply the first force F₁ by engaging a reduction gear 54 with the actuator 36, thereby increasing the actuator's mechanical leverage. With the application of thus increased closing force (the first force F₁) the open access door 32 may be fully closed and latched. The electronic controller 46 may be additionally configured to determine when the force required to fully close and latch the door 32 doesn't exceed the threshold force value 50. In such an embodiment, the electronic controller 46 may trigger the actuator 36 to apply a second force F₂ (and a resultant torque) that does not exceed the threshold force value 50. In other words, the second force F₂ is applied when a regular closing force is deemed sufficient to fully close and latch the open access door 32.

Specifically, the electronic controller 46 may be configured to apply the second force F₂ by triggering a second predetermined PWM signal 56 (what is the specification of the PWM signal 56?). The electronic controller 46 may be additionally configured to, following an initial application of the second force F₂ (which may extend a predetermined duration of time programmed into the controller), determine (using the corresponding door position sensor 42 and/or latch sensor 43) when the access door 32 has not fully closed and latched. The electronic controller 46 may then continue to apply, i.e., extend application of, the second force F₂ and thereby maintain a closing force on the door 32 and block the door from opening, for example until a vehicle operator is able to attend to the door. The electronic controller 46 may be additionally configured to determine when the force required to fully close and latch the door 32 exceeds the threshold force value 50 by determining when the vehicle 10 is situated on an incline θ tending to resist closure of the door.

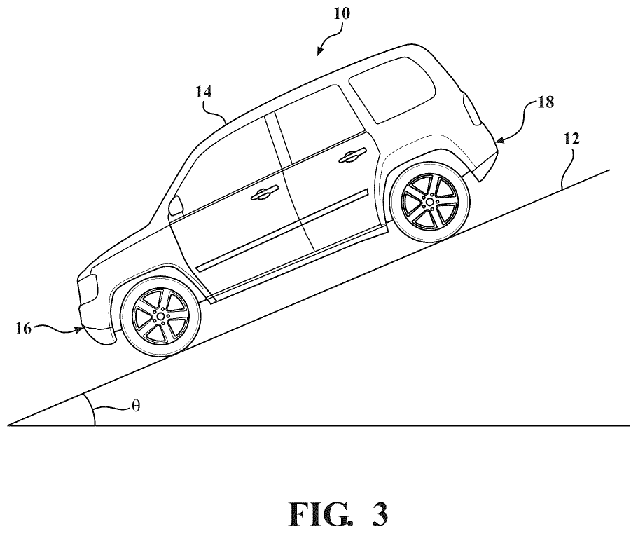

For example, in the vehicle 10 having forward hinged side doors 32, the vehicle would be positioned with its front end 16 directed down such an incline θ such that the force of gravity would tend to keep the door open (shown in FIG. 3). When the incline θ exceeds a threshold angle value 58 (shown in FIGS. 1 and 2), the force of gravity may overcome friction in the door mounting and/or articulation hardware as well as the actuator 36 and swing or slide the door open. The incline θ may be detected by a vehicle sensor 60. The threshold angle value 58 may be programmed into the electronic controller 46 for comparison versus a magnitude detected by the vehicle sensor 60.

The electronic controller 46 may also be configured to determine when the force required to fully close and latch the door 32 exceeds the threshold force value 50 by determining when ambient temperature exceeds a first threshold temperature value 62 (shown in FIGS. 1 and 2). Fluctuations in ambient temperature may influence the friction in the door mounting and/or articulation hardware as well as the actuator 36. Ambient temperature may be determined via a temperature sensor 64 arranged on the exterior of the vehicle body 14 and in communication with the electronic controller 46. The electronic controller 46 may be further configured to determine when the force required to fully close and latch the door 32 exceeds the threshold force value 50 by determining when ambient temperature is below a second threshold temperature value 66 (shown in FIGS. 1 and 2). When ambient temperature is outside the range defined by the first and second threshold values 62, 66, the force required to close the access door 32 may need to be increased.

The vehicle's infotainment system may be used to generally inform the vehicle operator of the system 40 status, such as via a display screen 68. The electronic controller 46 may be additionally configured to determine if full closure and latching of the door 32 has failed (e.g., using the corresponding door position sensor 42 and/or latch sensor 43) and, if such an event is detected, generate a sensory signal or alert 70 (auditory and/or visual) to the vehicle operator ((shown in FIGS. 1 and 2)). The electronic controller 46 may be further configured to determine when the full closure and latching of the door 32 has failed and set a countdown timer 72 before triggering the actuator 36 to power close the door. The countdown timer 72 may be displayed using the vehicle's infotainment system to inform the operator of the pending power closure.

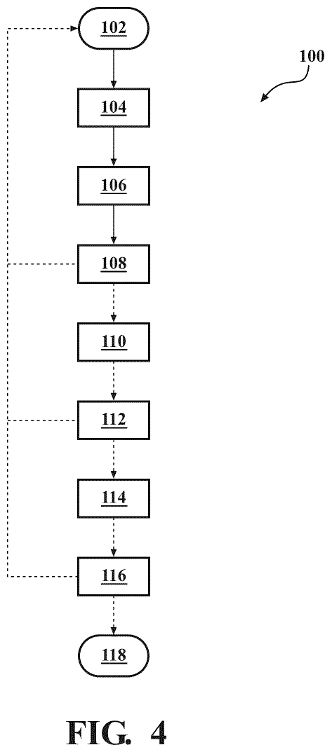

FIG. 4 depicts a method 100 of operating the vehicle access door 32, via the system 40 described above with respect to FIGS. 1-3. Overall, method 100 is intended to provide automatic power closing of the vehicle's open access door 32 in the event the vehicle is in motion. The method commences in frame 102 by identifying, via the electronic controller 46, when vehicle 10 is in motion, which may be accomplished using the sensor 48 or by identifying that the powertrain 38 is operating in propulsion mode 38A. Following frame 102, the method advances to frame 104. In frame 104 the method includes determining, via the electronic controller 46 using door position sensor(s) 42 and/or the latch sensor(s) 43, when access door(s) 32 are not fully closed and latched via the respective door mechanism(s) 32A. After frame 104, the method moves on to frame 106. According to the disclosure, in frame 106, the method includes determining, via the electronic controller 46, when the force required to fully close and latch the subject door 32 using the actuator 36 exceeds a threshold force value 50.

After frame 106, the method proceeds to frame 108 to power close the detected access door 32. In frame 108, the method specifically includes triggering the actuator 36, via the electronic controller 46, to apply the first force F₁ configured to exceed the threshold force value 50 to fully close and latch the door 32. The determination when the force required to fully close and latch the door 32 exceeds the threshold force value 50 may include determining when the vehicle 10 is situated on an incline (e.g., exceeding the threshold angle value 58) that tends to resist closure of the door. The determination when the force required to fully close and latch the door 32 exceeds the threshold force value 50 may also include determining when ambient temperature is outside of a temperature range bounded the first and second threshold temperature values 62, 66, as described above with respect to FIGS. 1-3.

As also described with respect to FIGS. 1-3, applying the first force F₁ may include triggering a series of first predetermined (100%) pulse width modulated (PWM) signals 52. Applying the first force F₁ may also include increasing voltage to the actuator 36 or engaging the reduction gear 54 with the actuator. Following frame 108, the method may advance to frame 110. In frame 110, the method includes determining, via the electronic controller 46, when the force required to fully close and latch the door 32 doesn't exceed the threshold force value 50. After frame 110, the method may proceed to frame 112 and include applying, via the electronic controller 46 using the actuator 36, the second force F₂ that doesn't exceed the threshold force value 50 to fully close and latch the door 32. Applying the second force F₂ may include triggering, via the electronic controller 46, the second predetermined pulse width modulated (PWM) signal 56.

Following initially applying the second force in frame 112 the method may advance to frame 114 for determining, via the electronic controller 46 using the door position sensor 42 and/or the latch sensor 43, when the access door 32 has not fully closed and latched. After frame 114, the method may move on to frame 116 to continue or extend application of the second force F₂ to maintain a closing force on the access door 32 and thereby block the door from opening, such as until a vehicle operator attends to the door. In each of frames 106, 110, and 114, the method may additionally determine when full closure and latching of the access door 32 has failed and display, via the electronic controller 46, the alert 70 to the vehicle operator. Additionally, in each of frames 106, 110, and 114, the method may include triggering (and displaying), via the electronic controller 46, the countdown timer 72 before triggering the actuator 36 to power close the open/unlatched access door 32. Following each of the frames 108, 112, and 116, the method may return to frame 102 or conclude in frame 118.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for operating an access door in a vehicle having a vehicle body, the system comprising:
a powertrain configured to operate the vehicle in propulsion mode;
a door mechanism configured to latch the door to the vehicle body;
an actuator configured to apply a force to the door to affect door closure and latching;
a sensor configured to detect a state of the access door relative to the vehicle body; and
an electronic controller in communication with the sensor and the actuator, and configured to:
identify when the vehicle is in motion relative to a road surface and determine, using the sensor, when the access door is not fully closed and latched;
determine when a force required to fully close and latch the door using the actuator exceeds a threshold force value; and
applying, via the actuator, a first force exceeding the threshold force value to fully close and latch the door.

2. The system according to claim 1, wherein the electronic controller is configured to apply the first force by triggering a series of first predetermined pulse width modulated (PWM) signals.

3. The system according to claim 1, wherein the electronic controller is configured to apply the first force by increasing voltage to the actuator.

4. The system according to claim 1, wherein the electronic controller is configured to apply the first force by engaging a reduction gear with the actuator.

5. The system according to claim 1, wherein the electronic controller is additionally configured to:
determine when the force required to fully close and latch the door doesn't exceed the threshold force value; and
apply, using the actuator, a second force not exceeding the threshold force value to fully close and latch the door.

6. The system according to claim 5, wherein the electronic controller is configured to apply the second force by triggering a second predetermined pulse width modulated (PWM) signal.

7. The system according to claim 5, wherein the electronic controller is additionally configured to:
following the application of the second force, determine, using the sensor, when the access door has not fully closed and latched; and
continue to apply the second force to maintain a closing force on the door and thereby block the door from opening.

8. The system according to claim 1, wherein the electronic controller is configured to determine when the force required to fully close and latch the door exceeds the threshold force value by determining when the vehicle is situated on an incline tending to resist closure of the door, and wherein the incline exceeds a threshold angle value.

9. The system according to claim 1, wherein the electronic controller is configured to determine when the force required to fully close and latch the door exceeds the threshold force value by determining when ambient temperature exceeds a first threshold temperature value.

10. The system according to claim 1, wherein the electronic controller is configured to determine when the force required to fully close and latch the door exceeds the threshold force value by determining when ambient temperature is below a second threshold temperature value.

11. A method of operating an access door in a vehicle having a vehicle body and a powertrain, the method comprising:
identifying, via an electronic controller, when the vehicle is in motion relative to a road surface;
determining, via the electronic controller using a sensor configured to detect a state of the access door relative to the vehicle body, when the access door is not fully closed and latched via a door mechanism;
determining, via the electronic controller, when a force required to fully close and latch the door using an actuator exceeds a threshold force value; and
applying, via the electronic controller using the actuator, a first force exceeding the threshold force value to fully close and latch the door.

12. The method according to claim 11, wherein applying the first force includes triggering a series of first predetermined pulse width modulated (PWM) signals.

13. The method according to claim 11, wherein applying the first force includes increasing voltage to the actuator.

14. The method according to claim 11, wherein applying the first force includes engaging a reduction gear with the actuator.

15. The method according to claim 11, further comprising:
determining, via the electronic controller, when the force required to fully close and latch the door doesn't exceed the threshold force value; and
applying, via the electronic controller using the actuator, a second force not exceeding the threshold force value to fully close and latch the door.

16. The method according to claim 15, wherein applying the second force includes triggering, via the electronic controller, a second predetermined pulse width modulated (PWM) signal.

17. The method according to claim 15, further comprising:
following applying the second force, determining, via the electronic controller using the sensor, when the access door has not fully closed and latched; and
continuing to apply the second force to maintain a closing force on the door and thereby block the door from opening.

18. The method according to claim 11, wherein determining when the force required to fully close and latch the door exceeds the threshold force value includes determining when the vehicle is situated on an incline tending to resist closure of the door, and wherein the incline exceeds a threshold angle value.

19. The method according to claim 11, wherein determining when the force required to fully close and latch the door exceeds the threshold force value includes determining when ambient temperature is outside of a temperature range bounded a first threshold temperature value and a second threshold temperature value.

20. A system for operating an access door in a vehicle having a vehicle body, the system comprising:
a powertrain configured to operate the vehicle in propulsion mode;
a door mechanism configured to latch the door to the vehicle body;
an actuator configured to apply a force to the door to affect door closure and latching;
a sensor configured to detect a state of the access door relative to the vehicle body; and
an electronic controller in communication with the sensor and the actuator, and configured (programmed) to:
identify when the vehicle is in the propulsion mode and detect, using the sensor, when the access door is not fully closed and latched;
determine when a force required to fully close and latch the door using the actuator exceeds a threshold force value;
trigger the actuator to apply a first force exceeding the threshold force value to fully close and latch the door;
determine when the force required to fully close and latch the door doesn't exceed the threshold force value;
apply, using the actuator, a second force not exceeding the threshold force value to fully close and latch the door;
following the application of the second force, determine, using the sensor, when the access door has not fully closed and latched; and
continue to apply the second force to maintain a closing force on the door and thereby block the door from opening.
